(19) United States
(12) Patent Application Publication
(10) Pub. No.: US 2005/0151730 A1
(43) Pub. Date: Jul. 14, 2005

(54) Method, system and computer program for stereoscopic viewing of 3d medical images

(75) Inventor: Steven Lobregt, Eindhoven (NL)

Correspondence Address: PHILIPS INTELLECTUAL PROPERTY & STANDARDS, 595 MINER ROAD, CLEVELAND, OH, 44143, US

(73) Assignee: Koninklijke Philips Electronics N.V., 5621 BA Eindhoven (NL)

(21) Appl. No.: 10/509,644

(22) PCT Filed: Mar. 26, 2003
(86) PCT No.: PCT/IB03/01216

(30) Foreign Application Priority Data
Mar. 29, 2002 (EP) 02076296.9

(51) Int. Cl. G06T 15/00

(52) U.S. Cl. 345/419

(57) ABSTRACT

The invention concerns a method of visualising an internal hollow organ (3) of a subject based on a volumetric scan thereof. A number of three-dimensional images of the internal surface of the hollow organ are reconstructed. For each image an image (Li) is calculated for the left eye from a first view point li. Next an image for the right eye (Ri) is calculated from a second view point ri that differs from the first view point. The left eye image and the right eye image are combined into a pair (Li, Ri) to form a stereoscopic image that is shown using stereoscopic imager means. The invention also refers to a system and a computer program to carry out the method according to the invention.

The invention refers to a method of visualising an internal hollow organ of a subject based on a volumetric scan thereof, said method comprising the step of: a) Reconstructing a three-dimensional image of the inside of the hollow organ.

Such a method is known in the art and forms the basis for a number of computer programs designed by different experts in the field providing a virtual medical examination technique called “virtual endoscopy”. Based on a volumetric scan of a patient, for instance generated by means of Computed Tomography, a data model is created from which three-dimensional endoscopic images are reconstructed by means of known three-dimensional reconstruction techniques. A 3D path is defined through a tubular structure or hollow organ of interest after which the inside thereof is visualised by moving a virtual camera along this path and calculating 3D endoscopic images as seen from view points lying on the path. Such computer programs offer a medically skilled person an opportuity to examine the internal organs of the patient without the need for invasive examination like true endoscopy. The thus reconstructed 3D endoscopic images can for instance be evaluated on a computer by a medically skilled person for diagnosis.

The known method has the disadvantage that although the resulting 3D images are a true representation of the inner structure of the hollow organ the interpretation thereof remains difficult. In practice it appears for instance to be difficult for a user to keep track of the orientation of the virtual camera during interactive movement thereof. Furthermore the wide-angle view of the lens of the virtual camera appears unnatural to a human observer and thus hampers the interpretation.

It is an object of the method according to the invention to provide a method of the type as described above that provides a more natural view.

The method according to the invention is therefore characterised in that for each image the method comprises a number of technical measures described in the following steps of: b) Calculating an image for the left eye from a first view point; c) Calculating an image for the right eye from a second view point that differs from the first view point; d) Combining the left eye image and the right eye image into a pair to form a stereoscopic image; and e) Showing the stereoscopic image using stereoscopic imager means.

By providing stereoscopic images of the hollow organ instead of monoscopic images the user sees the images in a more natural way. Stereoscopic images provide additional information, such as depth information and height information of the images. Using this information the user is for instance able to better judge relations between objects and/or to clearly see curvatures and/or height differences allowing him or her to distinguish between flat or inclining areas. As a result thereof the observer will be able to interpret the patient data more accurately and has a greater chance of arriving at the correct diagnosis.

It is noted that steps b) through d) refer to the generation of stereoscopic images, which is known per se in the field of computer graphics. A method of this type is for instance described in U.S. Pat. No. 6,011,581. Contrary to the method according to the invention the known method is however not part of a method for performing virtual inspection of an internal hollow organ of a subject based on a volumetric scan thereof, such as virtual endoscopy.

In a first preferred embodiment of the method according to the invention, wherein step a) further comprises the step of: Defining a view path through the hollow organ, the method is Characterised in that, for each image the first view point lies on a first line and the second view point lies on a second line, which first and second lines extend essentially parallel to the view path, each on one side thereof. The user now follows the same path trough the hollow organ as during performance of virtual endoscopy in the known “monoscopic mode”, but sees the 3D images in a more natural stereoscopic view. In support of this embodiment the image for each viewpoint needs to be calculated separately.

In a second preferred embodiment of the method according to the invention, wherein step a) further comprises the steps of: Defining a view path through the hollow organ; and Reconstructing the images as seen from view points lying on the view path, the method is characterised in that, at least the first or the second view point lies on the view path. The amount of images to be calculated is equal to the amount of images necessary for the first embodiment. However, when the stereoscopic viewing technique is used in addition to the known monoscopic viewing technique, advantageously, for each stereoscopic pair only one additional image needs to be calculated. The monoscopic images for view points on the view path that are already calculated for the known monoscopic viewing technique can now be used as either the left or the right eye image of a stereoscopic pair. Hereby the overhead computations necessary to implement the method according to the invention are thus effectively minimised.

In a third preferred embodiment of the method according to the invention, wherein step a) further comprises the steps of: Defining a view path through the hollow organ; and Reconstructing the images as seen from view points lying on the view path, the method is characterised in that, both the first and second view point lie on the view path. By choosing the first and second viewpoint cleverly now effectively in this third preferred embodiment the number of images to be calculated is equal to the number of images to be calculated for the known monoscopic method. The method according to the invention may also be implemented in addition to the known monoscopic method without any necessary overhead computations. Use can then be made of images that are already calculated for viewpoints on the view path for the known monoscopic method. The already calculated images for viewpoints on the path are most efficiently alternately used as first or second viewpoint.

In a further preferred embodiment of the method according to the invention the distance between the first and the second viewpoint is essentially one or more millimetres. The resulting view appears to be most natural for a human observer.

Preferably the view direction in the first and the second viewpoint is essentially parallel. Again the objective thereof is to simulate the normal view of a human observer, thus facilitating a correct interpretation of the imaged data, which in turn will greatly enhance the chance that the correct diagnosis is made.

According to another preferred embodiment of the method according to the invention step e) further comprises the steps of: showing the left and right eye image forming a stereoscopic image with different modification; and arranging the stereoscopic imager means such that the left eye image is passed to the left eye and the right eye image is passed to the right eye. Different modification of the left and right eye images in combination with suitable stereoscopic imager means is a practical way to accomplish stereoscopic vision. Various techniques hereof are known per se in the relevant art. In a first detailed embodiment use is made of so-called “passive” stereoscopic imager means. The left and right eye image of a stereoscopic image is shown with different polarization; and the stereoscopic imager means are provided with correspondingly differently polarized viewing means for respectively the left and right eye. In a second detailed embodiment the left and right eye image of a stereoscopic image are shown with different time-multiplexation. So-called “active” stereoscopic imager means are used with different viewing means for the left and right eye that are to be activated separately by a control unit based on corresponding time-multiplexation signals. In order to provide a geometrically correct image the viewing means are preferably incorporated in a head-mountable display.

According to another preferred embodiment of the method according to the invention the stereoscopic imager means comprise a lenticular screen. Lenticular screens are known per se in the relevant art. Advantageously these screens are able to show a stereoscopic image as such without the need for an observer to use or wear any assisting means.

The invention also refers to a system for visualising an internal hollow organ of a subject based on a volumetric scan thereof, which system comprises means for carrying out the steps of the method according to the invention.

The invention further refers to a computer program to carry out the method according to the invention.

The invention will be further explained by means of the attached drawing, in which:

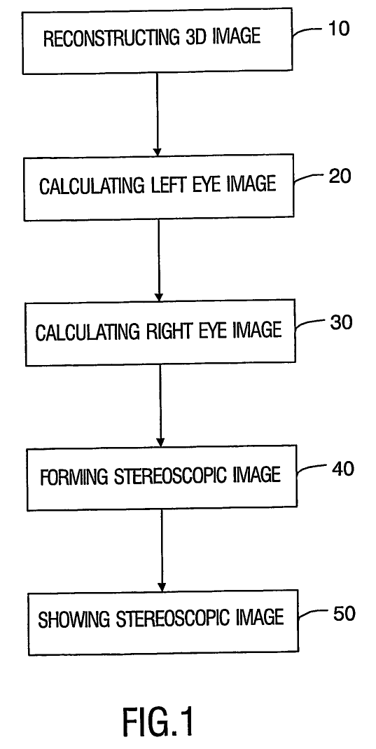

FIG. 1 shows a flow diagram presenting an overview of the steps of the method according to the invention;

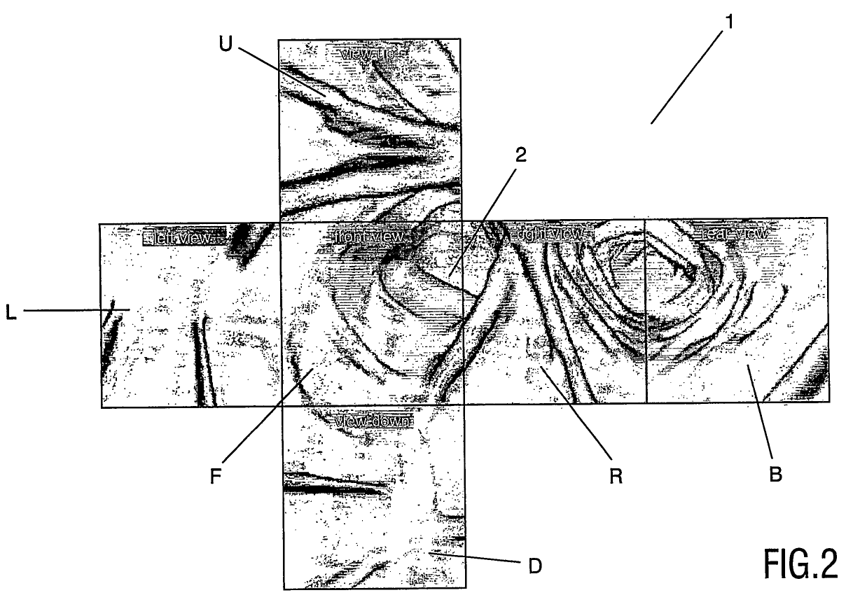

FIG. 2 shows an example of a monoscopic image as part of a simulated endoscopic view according to the state of the art;

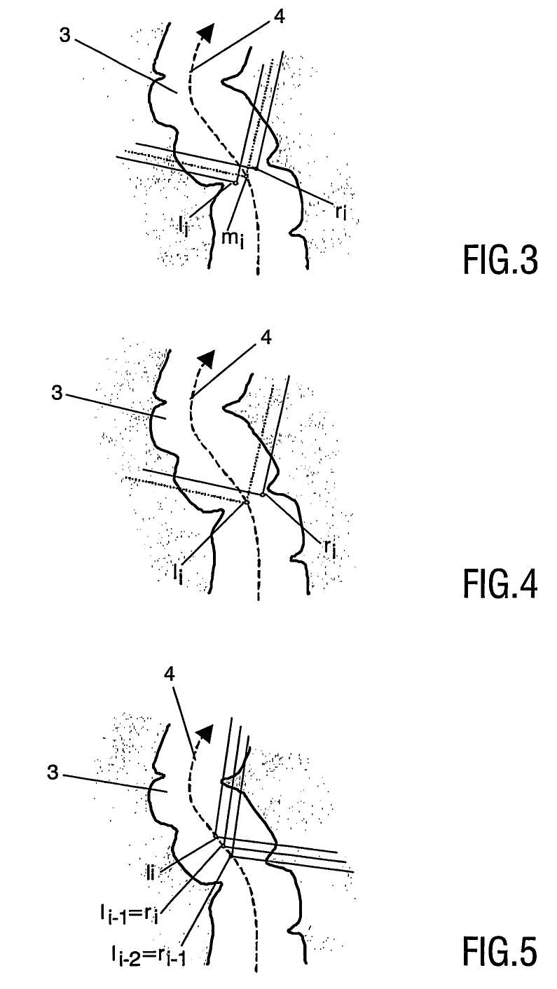

FIG. 3 schematically illustrates a first preferred embodiment of the method according to the invention;

FIG. 4 schematically illustrates a second preferred embodiment of the method according to the invention; and

FIG. 5 schematically illustrates a third preferred embodiment of the method according to the invention.

In all figures equal objects are denoted with equal reference numerals.

In general the method according to the invention refers to virtual inspection techniques for examination, for instance medical examination, of a subject which is usually a human patient, but can also for instance be an animal. Said techniques allow an inner view of hollow structures of the subject, e.g. organs, blood vessels, etc., by means of computer graphics. A virtual camera is placed in a three-dimensional data volume representing (art of) the subject. The method according to the invention will now be described according to a preferred embodiment, which relates to virtual endoscopy performed on the colon of a human patient.

In order to require the 3D patient data several known medical examination techniques can be used to acquire a volumetric scan, such as Computed Tomography (CT) or Magnetic Resonance Tomography (MR). The 3D data are visualised by means of known three-dimensional reconstruction techniques. For this purpose different suitable volume rendering techniques are known in the field of computer graphics. Preferably use is made of iso-surface volume rendering techniques, which are for instance described in the article “Iso-surface volume rendering”, by M. K. et al., Proc. of SPIE Medical Imaging '98, vol. 3335, pp 10-19. Thus a virtual environment is created that simulates endoscopy.

FIG. 1 shows a flow diagram presenting an overview of the steps of the method according to the invention. All of the steps will be separately discussed below.

Method Steps

Step 10: Reconstructing a Number of Three-Dimensional Images of the Internal Surface of the Hollow Organ;

A variety of visualisation techniques are available to the person skilled in the art to simulate a three-dimensional view of the colon through which a user may navigate. Several examples include:
a) the “unfolded cube” technique, wherein from each view point six views of the colon wall are calculated in mutually perpendicular directions, which views are projected onto the walls of a cube, which is next unfolded to provide a natural view of the colon; and
b) the “view point” technique, wherein from each view point one view in one direction is calculated as in real endoscopy;
c) the “stretched path” technique, wherein the colon wall is projected onto the walls of a cylinder, which is next unfolded and stretched.

All techniques result in a segmentation of the colon based on a voxel model comprising the data of a volumetric scan that is projected on a flat surface and represented as a surface model. Although the images created by means of virtual endoscopy are in the relevant field usually referred to as three-dimensional (3D) images, they are in fact more accurately described as the image of a two-dimensional projection of a 3D structure on a surface. Throughout this text these images will be referred to as 3D images.

The view point technique is a classical technique that is known in the art and among others described by Rogalla P, Terwisscha van Scheltinga J, Hamm B (Eds) in “Virtual endoscopy and related 3D techniques”, Berlin, Springer Verlag (2001). This book is part of the series Medical Radiology Diagnostic Imaging edited by: Baert A L, Sartor K, en Youker J E.

The stretched path technique is in more detail described in the following article by D. S. Paik, C. F. Beaulieu, R. B. Jeffrey, Jr., C. A. Karadi, S. Napel, “Visualization Modes for CT Colonography using Cylindrical and Planar Map Projections.” J Comput Assist Tomogr 24 (2), pages 179-88, 2000.

The unfolded cube technique is in more detail described in the article “Quicktime VR—an image based approach to virtual environment navigation”, by S. E. Chen, SIGGRAPH 95, held on 6-11 Aug. 1995, Los Angeles, Calif., USA, Conference Proceedings, Annual Conference Series, pages 29-38. A medical application of the unfolded cube technique is described in the following publication by F. Vos, I. Serlie, R. van Gelder, F. Post, R. Truyen, F. Gerritsen, J. Stoker, and A. Vossepoel, “A New Visualization Method for Virtual Colonoscopy”, in Medical Image Computing and Computer-Assisted Intervention—MICCAI 2001 (W. J. Niessen and M. A. Viergever, eds.), pp. 645-654, Springer-Verlag, October 2001.

According to the unfolded cube technique two-dimensional images resulting from the rendering techniques mentioned above are projected or mapped onto a plane or the sides of an object. The object is next unfolded in two-dimensions and stored. The resulting stored two-dimensional unfolded object image simulates a three-dimensional view from a viewpoint from within the object.

Various different objects can be used to map the environment on, such as a cube, a sphere, a cylinder, etc. Suitable projecting or mapping techniques are known per se in the field of computer graphics. The two-dimensional unfolded object images can be stored in different formats, for instance a general format, such as jpig or a specific format, such as a Quicktime VR-format. The resulting two-dimensional unfolded object images comprise a lot of information, but are suitable for display on a low-end computer.

An example of a stored two-dimensional unfolded object image resulting from the above projecting is shown in FIG. 2. Image 1 shows the inner colon wall of a patient. As can be clearly seen the originally two-dimensional images simulating the three-dimensional view are mapped on the sides of a cube 2, which is then folded open in two dimensions. The six sides of the cube are denoted as front (F), left (L), right (R), back (B), up (U) and down (D). This way the user is given an intuitive representation of the originally 3D information.

An image as shown in FIG. 2 can be calculated for a number of view points lying on a view path that is defined through the colon by means of known techniques. Preferably the calculated two-dimensional images are displayed in a sequence. This way the reviewer is given the impression to be immersed in the three-dimensional environment as if he or she could “fly through it”. A virtual environment based on the stored two-dimensional images can be calculated at one or more viewpoints in the three-dimensional view allowing interactive inspection of the virtual environment. This embodiment provides the user the possibility to dynamically inspect the environment of a viewpoint interactively.

However the image 1 according to the state of the art is a monoscopic image. According to the method of the invention stereoscopic images are calculated and shown thus providing the human observer a natural impression of the patient data including all relevant geometrical information, such as depth and height information.

The method according to the invention thus comprises for each image the following technical measures as described in steps 20 through 50. Three different preferred embodiments of the method according to the invention are illustrated in FIGS. 3 trough 5. All three figures show a picture of a colon 3 wherein a view path 4 is defined using known techniques. View points mᵢ (for i=1 . . . n, wherein n is the number of view points) represent positions on the view path for which monoscopic images Mᵢ are generated according to the method of the state of the art. Viewpoints lᵢ and rᵢ are positions for generating left and right eye images Lᵢ and Rᵢ to form a stereoscopic image according to the method of the invention.

Step 20: Calculating an Image for the Left Eye from a First Viewpoint.

As mentioned above several techniques are known in the field to calculate a three-dimensional monoscopic image Lᵢ from a first viewpoint lᵢ that is suitable for the left eye. When using the unfolded cube technique an image like image 1 can for instance be used as left eye image.

Step 30: Calculating an Image for the Right Eye from a Second Viewpoint that Differs from the First Viewpoint.

Once a method is chosen to calculate a monoscopic left eye image Lᵢ, the same method will be used to calculate a three-dimensional monoscopic right eye image Rᵢ. The right eye image is to be calculated from a second view point rᵢ that differs from the first view point lᵢ.

In order to create a natural view the view direction from both viewpoints lᵢ, rᵢ preferably is essentially parallel. However an image pair may also be calculated with converging view directions, in which case image distortions are created.

For the distance between both view points preferably the general rule applies that the distance between the view points should be approximately 1/30 part of the distance from the view points to the object(s) to be visualised, for instance the colon wall. In practice this leads to a preferred distance between the view points of one or more millimetres that may lie in the range of 1-5 millimetres, and more preferably in the range of 2-3 millimetres. General information about stereoscopic imaging can be found in: Jacobus G. Ferwerda, “The World of 3-D, A Practical Guide to Stereo Photography”, 1982.

Several approaches can be chosen to define the first and second view points lᵢ, rᵢ, which will be discussed below as part of three preferred embodiments.

Step 40: Combining the Left Eye Image and the Right Eye Image into a Pair to Form a Stereoscopic Image

FIG. 3 schematically illustrates a first preferred embodiment of the method according to the invention. According to this first preferred embodiment for each stereoscopic image (Lᵢ, Rᵢ) the first view point lᵢ lies left of the view path 4 and the second view point rᵢ lies right of the view path 4. Preferably the first viewpoint lᵢ lies on a first line (not shown) that essentially follows the view path at a certain distance. Preferably the second view point rᵢ lies on a second line (not shown) that essentially follows the view path at a certain distance. The first and second lines preferably lie on different sides of the view path. According to this embodiment two new monoscopic images Lᵢ and Rᵢ need to be generated for two view points lᵢ and rᵢ following the view path 4 to create a stereoscopic image (Lᵢ, Rᵢ) instead of one monoscopic image Mᵢ for view points mᵢ on the view path 4 according to the known method.

FIG. 4 schematically illustrates a second preferred embodiment of the method according to the invention. For each stereoscopic image at least the first viewpoint lᵢ or the second view point rᵢ lies on the view path 4. In FIG. 4 the first view point lᵢ lies on the view path 4 and the second view point rᵢ lies right of the view path 4. The first viewpoint lᵢ is now equal to the viewpoint mᵢ (see FIG. 3) for the method according to the state of the art. Preferably the second view point rᵢ lies on a line that essentially follows the view path 4 at a certain distance. According to this embodiment two monoscopic images Lᵢ and Rᵢ need to be generated for two view points lᵢ and rᵢ, lying respectively on and next to the view path 4, to create a stereoscopic image (Lᵢ, Rᵢ). In ease the stereoscopic viewing technique is used in addition to the known monoscopic viewing technique the already calculated monoscopic images Mᵢ for view points mᵢ lying on the view path can be efficiently used as either the left or the right eye images in each stereoscopic image.

FIG. 5 schematically illustrates a third preferred embodiment of the method according to the invention, wherein for each stereoscopic image (Lᵢ, Rᵢ) both the first view point lᵢ and the second view point rᵢ lie on the view path 4. The resulting stereoscopic image provides a side view perpendicular to the direction of the view path 4. In case the stereoscopic viewing technique is used in addition to a known monoscopic viewing technique wherein monoscopic side view images Mᵢ are already calculated for view points mᵢ lying on the view path, these can be efficiently used as both the left and the right eye images in each stereoscopic image. In FIG. 5 a number of corresponding pairs of viewpoints are indicated (lᵢ, rᵢ) and (lᵢ₋₁, rᵢ₋₁) where rᵢ=lᵢ₋₁ and rᵢ₋₁≈lᵢ₋₂. This applies for instance to the unfolded cube technique, discussed above, comprising four side views, respectively, L, R, U and D. The amount of images to be calculated is now equal to the amount of images to be calculated for the known monoscopic viewing technique.

Step 50: Showing the Stereoscopic Image Using Stereoscopic Imager Means.

Once the stereoscopic images are generated they now need to be shown to the observer. Generally this is performed by the following two steps: Showing the left and right eye image forming a stereoscopic image with different modification; and Arranging the stereoscopic imager means such that the left eye image is passed to the left eye and the right eye image is passed to the right eye.

In the field of computer graphics different techniques to accomplish this type of modification are available. Some of them will be discussed below.

Firstly the modification can be accomplished by alternately showing the left and right eye image of a stereoscopic image with different polarization. A human observer may then view the images using stereoscopic imager means that are provided with correspondingly differently polarized viewing means for respectively the left and right eye. In practice the left and right eye images can for instance be alternately shown on a screen at high frequency, while the observer for instance wears polarized glasses.

Secondly the modification can be accomplished by showing the left and right eye image of a stereoscopic image with different time-multiplexation. The stereoscopic imager means then need to be provided with different viewing means for the left and right eye, that are to be activated separately by a control unit based on corresponding time-multiplexation signals. For this purpose an LCD shutter may be used that is controlled by a computer using infrared signals.

Preferably the stereoscopic images are viewed under the same or like conditions under which the stereoscopic images were calculated or recorded. In this respect the viewing angle and perspective are relevant. By incorporating the viewing means in a head-mountable display a geometrically correct presentation of the stereoscopic images can be assured.

Thirdly, as an alternative to the first and second showing techniques the stereoscopic imager means may comprise a lenticular screen. Lenticular screens comprise an array of cylindrically shaped lenses that are able to show a stereoscopic image directly without the need for any viewing means to be worn by the observer. Lenticular screens are known per se in the art and are for instance described in American Patents U.S. Pat. No. 6,064,424 en U.S. Pat. No. 6,118,584, both by the same present applicant.

It is noted that throughout this text the words left eye and right eye are interchangeable.

The method according to the invention is preferably carried out by a system for visualising an internal hollow organ of a subject based on a volumetric scan thereof, which systems comprises means for carrying out the steps of the method according to the invention. Said means preferably comprise a computer program. Based on the explanation given herein a skilled person will be able to translate the steps of the method into such a computer program to carry out the method.

The system described can be directly coupled to the data acquisition system for acquiring the data of the subject concerned. This data set can be acquired by means of various techniques, such as 3D X-ray rotational angiography, computed tomography, magnetic resonance imaging or magnetic resonance angiography.

Summarising the invention refers to a method of performing virtual inspection, such as virtual endoscopy, by showing 3D patient data by means of stereoscopic images in order to reveal more detail thereof. The method is especially developed for use in a medical environment to increase the accuracy of inspection and thus the accuracy of patient diagnosis. Application of this method results in a virtual image yielding medical information, that can be used as an alternative to invasive methods, such as colonoscopy and bronchioscopy.

The invention is of course not limited to the described or shown embodiment. The method may be used to visualise surface details of other medical objects, such as blood vessels or trachea, and may even be used outside the field of medicine. The invention therefore generally extends to any embodiment, which falls within the scope of the appended claims as seen in light of the foregoing description and drawings.

1. A method of visualising an internal hollow organ of a subject based on a volumetric scan thereof, said method comprising the step of:
a) Reconstructing a number of three-dimensional images of the internal surface of the hollow organ;
characterised in that for each image the method comprises the steps of:
b) Calculating an image for the left eye from a first view point;
c) Calculating an image for the right eye from a second view point that differs from the first view point;
d) Combining the left eye image and the right eye image into a pair to form a stereoscopic image; and
e) Showing the stereoscopic image using stereoscopic imager means.

2. Method according to claim 1, wherein step a) further comprises the steps of:
I. Defining a view path through the hollow organ; and
II. Reconstructing the images as seen from view points lying on the view path, characterised in that, at least the first or the second view point lies on the view path.

3. Method according to claim 1, wherein step a) further comprises the steps of:
I. Defining a view path through the hollow organ; and
II. Reconstructing the images as seen from view points lying on the view path, characterised in that, both the first and second view point lie on the view path.

4. Method according to claim 3, wherein view points on the view path are alternately used as first or second view point.

5. Method according to claim 1, wherein step a) further comprises the steps of:
I. Defining a view path through the hollow organ, the method being characterised in that, for each image the first view point lies on a first line and the second view point lies on a second line, which first and second lines extend essentially parallel to the view path at a certain mutual distance.

6. Method according to claim 1, wherein the distance between the first and the second view point is essentially one or more millimetres.

7. Method according to claim 1, wherein the view direction in the first and the second view point is essentially parallel.

8. Method according to claim 1, wherein step e) further comprises the steps of:
I. Showing the left and right eye image forming a stereoscopic image with different modification; and
II. Arranging the stereoscopic imager means such that the left eye image is passed to the left eye and the right eye image is passed to the right eye.

9. Method according to claim 8, wherein step I comprises the step of:
Alternately showing the left and right eye image of a stereoscopic image with different polarization; and wherein step II comprises the step of:
Providing the stereoscopic imager means with correspondingly differently polarized viewing means for respectively the left and right eye.

10. Method according to claim 8, wherein step I comprises the step of:
Showing the left and right eye image of a stereoscopic image with different time-multiplexation, and wherein step II comprises the step of:
Providing the stereoscopic imager means with different viewing means for the left and right eye that are to be activated separately by a control unit based on corresponding time-multiplexation signals.

11. Method according to claim 9, wherein the viewing means are incorporated in a head-mountable display.

12. Method according to claim 1, wherein the stereoscopic imager means comprise a lenticular screen.

13. A system for visualising an internal hollow organ of a subject based on a volumetric scan thereof, which systems comprises:
a) means for reconstructing a number of three-dimensional images of the internal surface of the hollow organ;
characterised in that for each image the method comprises the steps of:
b) means for calculating an image for the left eye from a first view point;
c) means for calculating an image for the right eye from a second view point that differs from the first view point;
d) means for combining the left eye image and the right eye image into a pair to form a stereoscopic image; and
e) means for showing the stereoscopic image using stereoscopic imager means.

14. A computer readable media comprising a program to carry out the method according to claim 1.

15. Method according to claim 10, wherein the viewing means are incorporated in a head-mountable display.
